(19) United States
(12) Patent Application Publication
(10) Pub. No.: US 2025/0334441 A1
(43) Pub. Date: Oct. 30, 2025

(54) ARRANGEMENT AND METHOD OF A TUBE-BUNDLE REACTOR AND A SENSOR DEVICE

(71) Applicant: BASF SE, Ludwigshafen am Rhein (DE)

(72) Inventors: Ulrich HAMMON, Mannheim (DE); Friedhelm FUTTERER, Giesen (DE); Dirk WEHRHAHN, Hannover (DE); Ulrich CREMER, Ludwigshafen am Rhein (DE)

(21) Appl. No.: 18/855,366

(22) PCT Filed: Apr. 4, 2023
(86) PCT No.: PCT/EP2023/058881

§ 371 Date: Oct. 9, 2024

(30) Foreign Application Priority Data
Apr. 11, 2022 (EP) 22167690.1

(51) Int. Cl. G01F 23/2962; B01J 8/00; B01J 8/06

(52) U.S. Cl. CPC G01F 23/2962; B01J 8/001; B01J 8/06; B01J 2208/00654; B01J 2208/06

(57) ABSTRACT

The present invention relates to an arrangement of a tube-bundle reactor (1) and a sensor device (2), wherein the tube-bundle reactor (1) comprises a bundle of vertically arranged reaction tubes (3), which are open on top through upper openings and are fillable with particles of a catalyst material (4). The sensor device (2) comprises an ultrasonic sensor (6) and an evaluation device (7), wherein the ultrasonic sensor (6) is designed to emit an ultrasonic signal from above into one of the reaction tubes (3) and to receive the ultrasonic signal reflected in the reaction tube (3). The evaluation device (7) is coupled with the ultrasonic sensor (6) via a data connection (8) and is designed to ascertain the distance of the surface of the particles of the catalyst material (4) received by the one reaction tube (3) to the ultrasonic sensor (6) from the time-of-flight of the received ultrasonic signals and to ascertain a fill level height of the catalyst material (4) in the reaction tube (3) therefrom.

The present invention relates to an arrangement of a tube-bundle reactor and a sensor device, wherein the tube-bundle reactor comprises a bundle of vertically arranged reaction tubes, which are open on top through upper openings and are fillable with particles of a catalyst material. Furthermore, the invention relates to a method for determining the fill level height of a catalyst material in the reaction tubes of a tube-bundle reactor by means of such an arrangement.

The catalyst filling of a tube-bundle reactor is a very important step for the performance of the reactor. In addition to other parameters, uniform filling of all reaction tubes is a prerequisite for an optimum yield of the products produced using the reactor.

A tube-bundle reactor charging device is described for this purpose in DE 10 2006 013 488 A1, which has metering chambers that are fillable with filler material, such as catalytically coated carrier material, wherein each tube of the tube-bundle reactor is fillable via a feed device that adjoins the metering chamber.

To ensure uniform filling, however, the fill level heights of all reaction tubes have to be checked very carefully after the catalyst filling process. The fill level height is presently determined by manually inserting a measuring rod into each tube. Since a tube-bundle reactor generally has 20 000 to 40 000 tubes, this method is cumbersome and time-consuming and requires a high level of attentiveness and motivation of the participating personnel. In addition, there is the risk that the catalyst will be damaged if the measuring rod is placed excessively hard on the catalyst.

The present invention is therefore based on the object of providing an arrangement and a method of the type mentioned at the outset, using which the fill level height of the particles of the catalyst material in a tube-bundle reactor can be determined faster, more cost-effectively, and with less susceptibility to error.

This object is achieved according to the invention by an arrangement having the features of claim 1 and by a method having the features of claim 12. Advantageous embodiments and further developments are revealed by the dependent claims.

The arrangement according to the invention for the tube-bundle reactor described at the outset comprises a sensor device, which comprises an ultrasonic sensor and an evaluation device, wherein the ultrasonic sensor is designed to emit an ultrasonic signal from above into one of the reaction tubes and to receive the ultrasonic signal reflected in the reaction tube, and wherein the evaluation device is coupled with the ultrasonic sensor via a data connection and is designed to determine the distance of the surface of the particles of the catalyst material received by the one reaction tube to the ultrasonic sensor from the time-of-flight of the received ultrasonic signals and to ascertain the fill level height of the catalyst material in the reaction tube therefrom.

The tube-bundle reactor is a chemical reactor in which in particular strongly exothermic reactions, usually oxidation reactions, are carried out in the gas phase. The gas mixture is reacted in reaction tubes, through which a coolant possibly flows, with the aid of a catalyst.

A catalyst material, which in particular consists of individual particles, is located in the reaction tubes. The particles typically have a spherical, solid-cylindrical, or hollow-cylindrical geometry. The ratio of diameter to length of the particles is usually in the range of 0.4 to 1.5 and the ratio of the particle diameter to the tube diameter is generally 1:15 to 1:3. The catalyst usually consists of mixtures of (noble) metals, metal mixed oxides, ceramic base materials such as oxides of silicon, magnesium, aluminum, and titanium. In individual cases, the catalyst only consists of one component. During the operation of the tube-bundle reactor, the activity and the selectivity of the catalyst material usually decreases with time, which results in a regular replacement of the catalyst. For an optimum yield of the reactor, the most perfect possible synchronization of all reaction tubes of a tube-bundle reactor is to be sought. To achieve this synchronization, the quality of the filled catalyst particles has to be as constant as possible over the entire batch of the filling. Quality features here are the intrinsic activity and selectivity of the catalyst compound, geometric parameters of the catalyst particles such as size and shape or the distribution thereof, and the mechanical properties such as the breaking strength of the filled catalyst particles. To ensure a uniform flow of the reactants through the individual reaction tubes, the filling quantity and the filling speed during the filling of the reactor have to be kept very constant in order to achieve the most uniform possible fill level height. While the geometrical, the catalytic, and/or the breaking-mechanical properties are checked or set in upstream tests during the catalyst production, the homogeneous filling of the reaction tubes has to be checked after the filling process, for which purpose the arrangement is used.

For this purpose, the ultrasonic sensor is located according to one embodiment of the arrangement according to the invention directly above the opening of the reaction tube. The small distance between the emission surface of the ultrasonic sensor and the opening of the reaction tube is referred to as the offset. In another embodiment of the arrangement according to the invention, the ultrasonic sensor is plunged into the reaction tube.

The emission characteristic of the ultrasonic sensor is an ultrasonic lobe. The ultrasonic sensor of the arrangement according to the invention is in particular aligned so that the axis of symmetry of the ultrasonic lobe is parallel to the longitudinal axis of the reaction tube of the tube-bundle reactor. The ultrasonic signal is therefore emitted centrally into a reaction tube in parallel to the longitudinal axis of the reaction tube of the tube-bundle reactor. In this way, reflections of the ultrasonic signal on the walls of the reactor tube and on protruding contaminants in the reaction tube are advantageously avoided.

The time-of-flight of the signal is determined from the emission time of the signal and the reception time of the signal. These times are detected by the ultrasonic sensor and are each stored in the evaluation device. The evaluation device determines the fill level height from the time-of-flight. For this purpose, it is coupled according to one embodiment of the arrangement according to the invention with a temperature probe, which continuously carries out temperature measurements in the surroundings of the reaction tubes in order to ascertain the temperature-dependent speed of sound required for the calculation of the fill level height.

The fill level height is understood here as the distance from the bottom of the reaction tube, on which the particles of the catalyst material rest, to the upper surface formed by the particles of the catalyst material. In contrast, the fill level is understood as the distance of the surface of the particles of the catalyst material from the ultrasonic sensor.

The arrangement according to the invention has the advantage that the fill level height of the particles of the catalyst material in a tube-bundle reactor can be determined faster, more cost-effectively, and with less susceptibility to error with the aid of an ultrasonic sensor. Since the measurement of the fill level height of the filled catalyst particles by means of an ultrasonic sensor takes place in a contactless manner, in contrast to measuring rods, damage to the filled catalyst particles by the measuring process can be precluded. The automatic calculation of the fill level height simplifies and accelerates the measuring method. Costs are reduced in that the work time of the employees required for carrying out the measurements can be reduced and the wear of the catalyst material due to damage is minimized. Moreover, the measurement can be carried out more frequently with little effort, so that an optimized catalyst filling is ensured, from which an improved yield in the reaction process results.

According to one embodiment of the arrangement according to the invention, the ultrasonic sensor comprises an ultrasound transducer head having a decoupling surface for emitting the ultrasonic signal. An adaptation layer for adapting the emission characteristic of the ultrasonic sensor to the geometry of the reaction tubes is arranged on the decoupling surface.

The problem can arise during the measurement of the fill level height using an ultrasonic sensor that undesired reflections of the ultrasonic signal occur due to fine deposits on the tube walls. These corrupt the reflected signal due to additional echoes. The echoes from the deposits can be reduced by a smaller emission angle.

For this purpose, for example, commercial, round, planar ultrasonic transducers can be used. These have an ultrasound transducer head having a decoupling surface for emitting the ultrasonic signal, which is provided with an adaptation layer. The additional layer causes a change of the emission characteristic of the ultrasonic sensor. The ultrasonic lobe can be reduced, for example, in its cross-sectional diameter by the adaptation layer.

The emission characteristic of the ultrasonic sensor can advantageously thus be adapted very easily to the tube geometry. Due to the narrowed ultrasonic lobe, the signal is only emitted in the center of the tube, reflections on the edge of the tube or on deposits are reduced, and therefore corrupted time-of-flight measurements are precluded.

According to a further embodiment of the arrangement according to the invention, the thickness of the adaptation layer in the center of the decoupling surface is greater than at the edge. The thickness of the adaptation layer can rise suddenly or can also be produced by a continuous transition of the layer thickness from the outside at the edge of the coupling surface to the layer thickness on the inside, in the center. A special change of the emission characteristic arises depending on the geometry of the decoupling surface.

A narrow ultrasonic lobe can be generated particularly well by this arrangement, the width of which can be adapted optimally to the geometry of the reactor tube. Reflections on deposits on the walls of the reaction tube can thus advantageously be avoided even better. The ultrasonic signal only propagates in the center of the tube.

According to a further embodiment of the arrangement according to the invention, the adaptation layer has a first film which is fastened tightly to the decoupling surface. The first film can be, for example, an adhesive film. It is ensured by the use of a film, in particular an adhesive film, that no gaps form between ultrasound transducer head and adaptation layer. The air inclusions in the gaps would induce an undesired change of the ultrasonic signal due to the material transitions and obstruct a reliable evaluation of the signal. Furthermore, such adhesive films can be purchased inexpensively and in various embodiments, for example, in different thicknesses. The attachment to the ultrasound transducer head is very easy and the size of the layer can be easily adapted as desired.

According to a further embodiment of the arrangement according to the invention, the adaptation layer has a second film, which is smaller than the first film and is fastened on the side of the first film facing away from the decoupling surface in the center of the decoupling surface, so that the thickness of the adaptation layer is greater in the center of the decoupling surface than at the edge.

The ratio of the diameter of the smaller second film to the diameter of the larger first film is in particular in a range of 0.16 to 0.36, in particular this ratio is 0.26. Accordingly, the ratio of the area of the smaller second film to the area of the larger first film is in a range of 0.026 to 0.013, preferably 0.07. Measurement errors due to adhesions or encrustations on the inner walls of a reaction tube can be avoided by an adaptation layer designed in this way.

Due to the use of films, in particular two adhesive films, no gaps arise between the ultrasound transducer head, the first film, and the second film. The ultrasonic signal is therefore not corrupted by air inclusions between the material transitions. Furthermore, the two films can be attached very easily to the transducer head, in particular if they are adhesive films. The material of the two films can be selected variably in order to adapt the emission characteristic optimally to the existing properties of the reaction tubes. Different materials and thicknesses can also be selected for the first and second film. The radius of the second film is also freely selectable. Different ratios of the thickness of the film in the center and the thickness of the film in the edge area, as well as different ratios of the radii of the first film to the second film can therefore be created.

A changed emission characteristic of the ultrasonic lobe is thus advantageously generated very easily and cost-effectively, which is adapted particularly well to the measuring task, in particular the geometry of the reaction tubes.

According to a further embodiment of the arrangement according to the invention, the sensor device has an indicator, which is designed to display an optical signal that is dependent on the ascertained fill level height of the evaluation device.

The desired fill level height or a permitted range for the fill level height can be stored beforehand in the evaluation unit of the sensor device. This target value is compared after completed measurement to the measured actual value of the fill level height. It is output by means of the optical signal whether the measurement result is in the specified range. This can take place, for example, via a bar having light-emitting diodes (LED). Three different-colored LEDs are arranged on the ultrasonic sensor for this purpose, for example. If the fill level height is in the desired target range, a green LED lights up, if it is outside, thus below or above the selected range, a red LED lights up. Furthermore, it can be signaled via a yellow light if no measured value could be ascertained. This is the case, for example, if there were reflections from contaminants which have prevented an evaluation. It is also signaled by the yellow light if the fill level height is too low and/or the ultrasonic signal has too little power to receive an adequate reflected signal. With an excessively high fill level height, it is also not possible to reliably evaluate the reflected signal; this range is also called the “blind zone”. The reflected signal arrives at the ultrasonic sensor again so quickly here that it is still in the dead time after emission of the signal. A yellow LED is also displayed in this case. In addition, the result of the fill level height can be output in millimeters via a display on the ultrasonic sensor.

This arrangement advantageously enables the fill level height or any errors in the measurement to be identified quickly. The result of each measurement is displayed until starting the next measurement. Sufficient time thus remains to check the measurement and to stop the measuring process optionally for a correction of the filling or the start of a renewed measurement.

In one embodiment of the arrangement according to the invention, the sensor device alternatively or additionally has a component for generating an acoustic signal, which is designed to generate an acoustic signal. If the fill level height has been identified as below or above the desired value or as not measurable, thus upon display of the red or yellow LED, a brief warning tone additionally sounds, for example, via a loudspeaker. This enables an even easier and more automated check of the fill levels.

According to a further embodiment of the arrangement according to the invention, the ultrasonic sensor is fastened on a measuring carriage, which is attached on a rail system above the openings of the reaction tubes and is movable in a horizontal plane above the openings of the reaction tubes. The measuring carriage is in particular moved on profile rollers for more accurate guiding. The carriage can travel continuously; in particular it is thus not stopped when measurement is performed using the ultrasonic sensor.

If the ultrasonic sensor is located in a central area above a reaction tube during the continuous travel of the measuring carriage, the measurement is started. In particular a speed monitoring unit is installed on the measuring carriage. Due to the small tube diameter, the carriage cannot travel excessively fast, so that sufficient time remains for the measurement. The measuring carriage can be moved manually or automatically on the rail system. In the case of excessively fast manual movement of the measuring carriage or if a correct measuring position cannot be assumed during the automatic journey of the measuring carriage, a warning tone sounds.

The measuring carriage has the advantage that the ultrasonic sensor is aligned on the measuring carriage matching with the reaction tubes. The correct alignment thus does not have to be reestablished for each individual measurement. This is important in particular because in the case of incorrect alignment of the sensor, the ultrasonic waves can be reflected on the tube jacket or dirt deposits seated there and the measurement cannot be carried out correctly. The measurement is thus less susceptible to error overall due to the measuring carriage. The measurement duration is chronologically very efficient due to the alignment on the rail system or the continuous advance.

According to a further embodiment of the arrangement according to the invention, the sensor device comprises a rechargeable accumulator, which is designed to ensure the voltage supply of the sensor device. An accumulator module is attached on the measuring carriage, which supplies both the measuring carriage and the ultrasonic sensor with power. This enables the arrangement to function without a direct connection to the power grid. If no measurements of the fill level heights currently have to be carried out, the accumulator can be charged.

According to a further embodiment of the arrangement according to the invention, the arrangement comprises an alignment device having light barrier sensors, which is designed to detect the relative location of the ultrasonic sensor to the reaction tube in a horizontal plane.

The alignment device can comprise a calculation unit in addition to the light barrier sensors. Upon the displacement of the sensor device, the light barrier sensors detect the relative location of the ultrasonic sensor to the reaction tube. The calculation unit calculates therefrom how the ultrasonic sensor has to be moved by means of the measuring carriage in order to align it so that the vertical axis of the ultrasound transducer head coincides with the longitudinal axis of the reaction tube.

For the detection of the reaction tube, in particular two light barriers offset in relation to one another in the direction of travel are combined to form a pair. The offset of the light barriers in relation to one another is approximately 5 mm less than the tube diameter. As long as both light barriers detect the tube opening simultaneously, the distance measurement is triggered and enabled. For reliable detection of the tube openings, there are two of these light barrier pairs, which are interconnected to form an OR linkage.

The light barrier pairs advantageously enable automated starting of the measurement of the fill level height, namely precisely when the ultrasonic sensor is placed directly above the permitted inner area in the reaction tube. The use of the light barrier pairs therefore increases the degree of automation of the measurement once again and lowers its susceptibility to error.

According to a further embodiment of the arrangement according to the invention, the sensor device comprises multiple ultrasonic sensors.

Due to the installation of the alignment device having measuring carriage, calculation unit, and light barrier pairs, the measurement is so strongly automated that it is possible to measure the fill level heights of multiple reaction tubes simultaneously. Multiple ultrasonic sensors which are arranged in a row, for example, are located on the measuring carriage. LEDs and a display for displaying the fill level height are assigned to each ultrasonic sensor, as was described above. This is particularly advantageous, since several thousand reaction tubes are arranged in a tube-bundle reactor, the fill level height measurement of which can be completed significantly faster by simultaneously carrying out measurements at multiple reaction tubes.

According to a further embodiment of the arrangement according to the invention, the reaction tubes are arranged in the tube-bundle reactor in a uniform grid or a uniform tube spacing, so that a repeating linear pattern results.

A grid is understood as a regular pattern distributed on a surface. The grid is formed by repeating displacement of this pattern in a horizontal plane. The reaction tubes are thus arranged in the horizontal plane so that during a horizontal movement over the tube openings, the same pattern is shown again and again at least in one direction.

A structured sequence of the selection of the reaction tubes during the measuring process can advantageously be found easily in this way.

According to a further embodiment of the arrangement according to the invention, the ultrasonic sensors are arranged on the measuring carriage so that they correspond to the repeating linear pattern of the grid of the reaction tubes. The ultrasonic sensors are thus aligned on the measuring carriage so that during a movement of the measuring carriage in the direction of the repeating pattern, the ultrasonic sensors are moved over the openings of the reaction tubes and after a specific advance of the measuring carriage, the vertical axis of these ultrasonic sensors coincides in each case with the longitudinal axis of a reaction tube. Due to this relative arrangement of the grid of the reaction tubes and the ultrasonic sensors on the measuring carriage, a linear movement of the measuring carriage without continuous displacement of the ultrasonic sensors on the measuring carriage for the individual measurements is enabled. Furthermore, all reaction tubes can be measured by a repeating displacement of the measuring carriage.

A plurality of ultrasonic sensors can be located on the measuring carriage, which all experience the same advance due to advancing the measuring carriage and can therefore be moved simultaneously above the reaction tubes. For example, the ultrasonic sensors are arranged adjacent to one another in a row and with equal distance to one another. This arrangement is reflected in the reaction tubes. Moreover, they are arranged in succession in rows. With a uniform advance of the measuring carriage, the reaction tubes are thus traveled over and measured one after another row by row. A plurality of reaction tubes can thus advantageously be measured simultaneously, wherein only a linear advance of the measuring carriage and no additional alignment of the individual ultrasonic sensors is necessary for this purpose. This arrangement thus results in an accelerated measuring method that is less susceptible to error.

In a further embodiment of the arrangement according to the invention, sound signals of adjacent ultrasonic sensors are damped in that the underside of the measuring carriage is provided with nonwoven material or felt, for example, by means of an adhesive tape, in the area of the ultrasonic sensors. These damping layers made of nonwoven material or felt are attached to the measuring carriage so that they suppress undesired reflections from other ultrasonic sensors.

The invention furthermore relates to a method for determining the fill level height of a catalyst material in the reaction tubes of a tube-bundle reactor using a sensor device, which comprises an ultrasonic sensor, using which an ultrasonic signal is emitted from above into one of the reaction tubes and the ultrasonic signal reflected in the reaction tube is received, and the received signal is transmitted via a data connection to an evaluation device, and the evaluation device ascertains, from the time-of-flight of the received ultrasonic signals, the distance of the surface of the particles of the catalyst material received by a reaction tube to the ultrasonic sensor and therefrom the fill level height of the catalyst material in the reaction tube.

The method according to the invention can be carried out in particular by the arrangement according to the invention. It has the same advantages as the arrangement according to the invention.

As soon as the ultrasonic signal is emitted in the method according to the invention, the starting time of the emission is transmitted to the evaluation device. The arrival time of the reflected signal at the ultrasonic sensor is also transmitted to the evaluation device. The distance measurement then takes place indirectly via a time-of-flight measurement of the ultrasonic signal.

Multiple ultrasonic pulses are emitted into the reaction tube during the measurement of the fill level height of a reaction tube. The power of the ultrasonic sensor for the emission of the ultrasonic pulses is selected so that a sufficiently large reflection signal can be detected even with empty tubes, thus maximum penetration depth of the signal.

Due to the geometry of the particles of the catalyst material, a variance in the fill level height results at different positions in the reaction tube in the order of magnitude of the particles of the catalyst material. This variance is not taken into consideration in the measurement, since the size of the particles and the variance in the fill level height resulting therefrom is small. To determine the distance of the emission surface of the sensor to the catalyst filling in the tube, the last time-of-flight signal which meets the quality requirements in the measurement is used to determine the fill level height of the corresponding tube and the corresponding speed of sound. A uniform propagation of the sound waves is assumed for this purpose and the ascertained distance is halved, in order to take into consideration only one distance and not the outgoing and return travel. The empty area in the reaction tube is ascertained from this distance minus the offset between the emission surface of the ultrasonic sensor and the opening of the reaction tube; the mean fill level height results from the tube length minus the empty area.

The speed of sound is temperature dependent. The temperature of the complete measurement setup influences the measurement insofar as a greater measurement error results when the temperature changes. With 3° C. difference in the surroundings, for example, a change of the error by 1% occurs. Therefore, in particular a continuous temperature measurement takes place in the surroundings of the reaction tubes via an additionally installed temperature probe. The speed of sound is adapted with the measured temperature, for example, for each measurement. In this way, it is possible to calculate the filling height with great accuracy using the actual speed of sound.

According to a further embodiment of the method according to the invention, in which the ultrasonic sensor is fastened on a measuring carriage, this is moved on a rail system by means of profile rollers as a guide in a horizontal plane above the openings of the reaction tubes and the relative horizontal location of the ultrasonic sensor to the reaction tube is measured by means of light barrier sensors. The ultrasonic sensor is aligned here so that the ultrasonic sensor is located centrally above an opening of a reaction tube.

An error-free measurement can only take place if the ultrasonic sensors are located having their emission surface directly above the tube openings. If this should not be the case, correct distance values cannot be ascertained. To ensure this, two light barriers shifted in relation to one another in the direction of travel of the measuring carriage are combined to form a pair for the tube detection. The offset of the light barriers in relation to one another is approximately 5 mm less than the tube diameter. As long as both light barriers detect the tube opening simultaneously, the distance measurement is triggered and enabled. For reliable detection of the tube openings, two of these light barrier pairs can be used simultaneously, which are interconnected to form an OR linkage. If one of the light barrier pairs should supply an unclear result, the result of the second light barrier pair can be used.

The light barrier pairs are attached on the carriage directly in front of the ultrasonic sensors arranged adjacent to one another. They detect the reaction tubes via reflection measurements. If both light barriers of a light barrier pair detect that the ultrasonic sensors are placed above the reaction tube, the ultrasonic measurement is started. A specific area is permitted for this purpose within the tube. This has the result that with uniform advance of the measuring carriage, a measuring time window arises.

The movement of the carriage can take place manually or automatically. Two different operating modes are available for this purpose. In manual operation, the carriage is moved by hand slowly above the reaction tubes. In automatic operation, in contrast, the carriage travels independently above the reaction tubes. If the ultrasonic sensor is located long enough over a reaction tube, a measurement can take place. The measurement takes place when the ultrasonic sensor is located above the inner area of the reaction tube. For example, in the case of a reaction tube which has a diameter of 20 to 25 mm, a measurement is carried out in an area of approximately 8 mm in the center of the reaction tube; if measurement were carried out closer to the edge, undesired reflections would possibly occur.

If one of the two light barrier pairs detects that the ultrasonic sensors are located completely above the tube openings, the fill level measurement is started. The measurement is repeated as long as the correct positioning above the tubes is provided. In addition, the measured values are compared to the stored target values and the result of the fill level height is displayed on the LED bar. As soon as the light barrier pair detects that the ultrasonic sensors are no longer located in the permitted area above the tube openings, the continuous measurement is stopped and the result is frozen in the LED bar. If a tube fill level has been detected as below or above the desired level or as not measurable (red or yellow LED), a brief warning tone additionally sounds. The result is retained until the next tube row or the next tube pattern is detected by the light barriers.

At excessively high speed, in particular all LEDs of the LED bar are switched off and an LED for signaling that the speed is exceeded lights up on the alignment device. No measured values are displayed on the display. In addition, a long warning tone sounds. The error display is canceled again with the next correct position.

If the carriage is moved excessively fast above the tubes in manual operation or if an excessively high speed of the measuring carriage is set in automatic operation, sufficient time does not remain to carry out a measurement above the tube openings. The time-of-flight of the ultrasonic signal is then possibly longer than the period of time in which the ultrasonic sensors are located correctly above the tube openings. To prevent this case, there is a specified highest traveling speed which is monitored by the light barriers.

If the measuring carriage is automatically operated, it automatically continues to travel after a completed measurement in order to position the ultrasonic sensor by means of the light barrier sensor pair above a new reaction tube. During manual operation, the measuring carriage is moved at slow, constant speed on rails above the tubes to be measured.

In case of error, the measuring carriage continues to travel for a small distance, so that the incorrectly measured reaction tube or the row of reaction tubes is exposed. It can thus, for example, be visually checked more easily why the measurement could not take place. The measuring carriage then stops with a warning tone. It is possible to continue with the measurement of the next reaction tube by a brief actuation of the rotating knob. The direction of travel is freely selectable in principle and can likewise be determined here via the rotating knob.

According to a further embodiment of the method according to the invention, multiple ultrasonic sensors are arranged adjacent to one another on the measuring carriage. Ultrasonic measurements for determining the fill level height of multiple reaction tubes are carried out simultaneously, wherein the ultrasonic sensors are alternately activated for the measurement.

In particular, adjacent ultrasonic sensors are not activated simultaneously. The crosstalk of adjacent ultrasonic sensors can thus advantageously be reduced. Crosstalk of adjacent ultrasonic sensors is understood as the undesired detection of ultrasonic signals of the adjacent sensor. This can be induced, for example, by reflections of the signal on contaminants.

Since the dwell time of the sensors above the reaction tubes is very short, the ultrasonic sensors cannot be triggered in succession. For this reason, the adjacent ultrasonic sensors are divided into two groups, which are then triggered alternately. For example, the ultrasonic sensors 1, 3, 5, 7, 9 form one group, the sensors 2, 4, 6, 8, 10 form the second group. Because no adjacent ultrasonic sensors are used simultaneously, no interfering signal can also originate therefrom to an adjacent ultrasonic sensor and this therefore cannot be incorrectly measured at the adjacent ultrasonic sensor.

According to a further embodiment of the method according to the invention, in a measuring period for a reaction tube, a plurality of times-of-flight of emitted ultrasonic signals are received and stored, the times-of-flight are compared in the evaluation device to a stored permitted time-of-flight interval, those times-of-flight are filtered out which are outside the permitted time-of-flight interval, and the fill level height of the catalyst material is ascertained from the permitted times-of-flight.

The permitted interval results, for example, from the theoretically possible values for the time-of-flight. With an empty tube, the value for the maximum time-of-flight would thus be expected and with a completely filled tube, the value for the minimum time-of-flight would be expected. The time-of-flight results from the speed of sound and the distance covered by the sound. This restriction offers a further possibility for minimizing interfering signals, which arise, for example, due to crosstalk of two adjacent sensors or due to residues in the tube.

The invention will now be explained on the basis of exemplary embodiments with reference to the drawings.

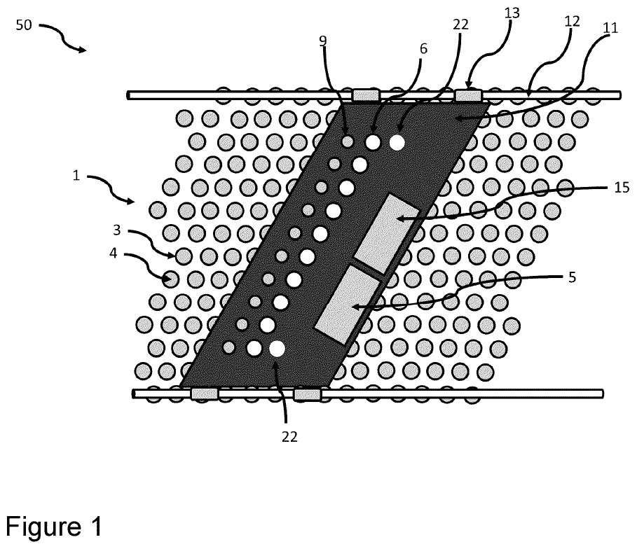

FIG. 1 shows a horizontal cross section of an exemplary embodiment of the arrangement according to the invention,

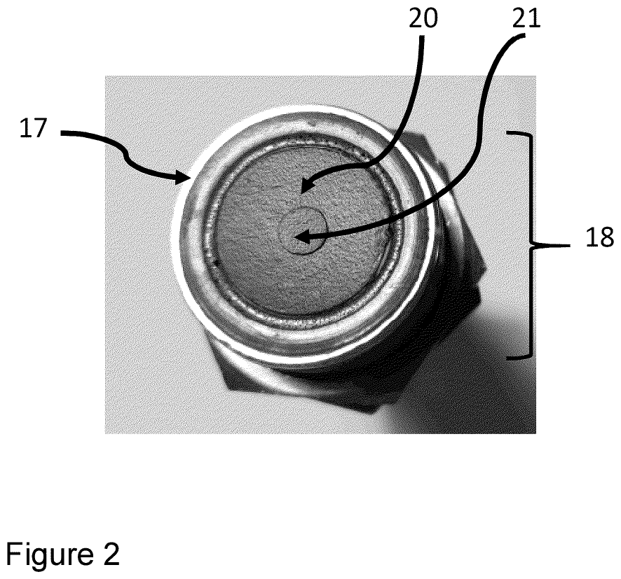

FIG. 2 shows an exemplary embodiment of an employed ultrasonic sensor having adaptation layer,

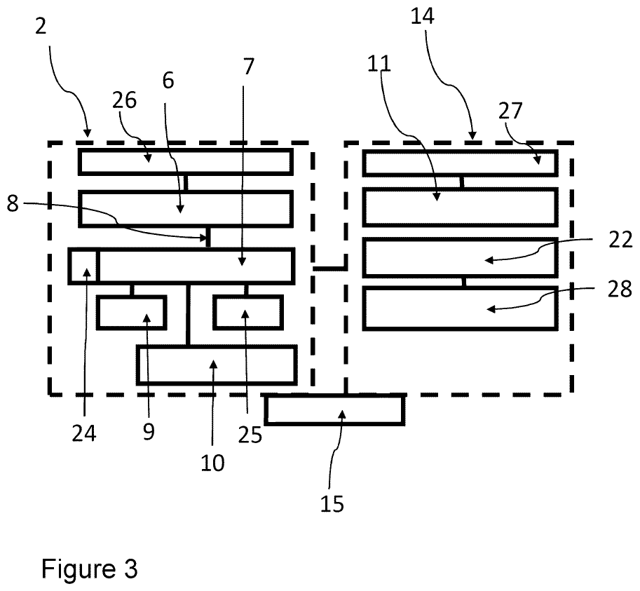

FIG. 3 schematically shows the components of the arrangement,

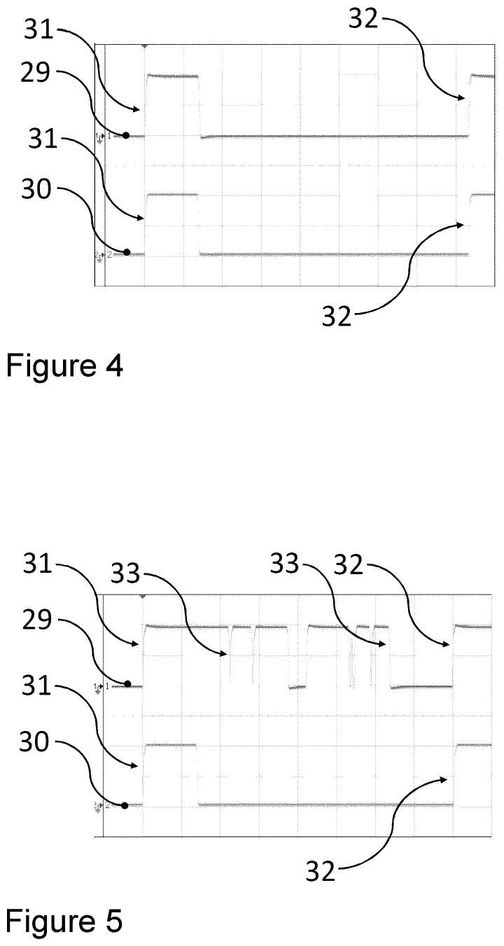

FIG. 4 shows the results of measurement on a reaction tube having clean inner walls,

FIG. 5 shows the results of measurement on a reaction tube having encrusted inner walls,

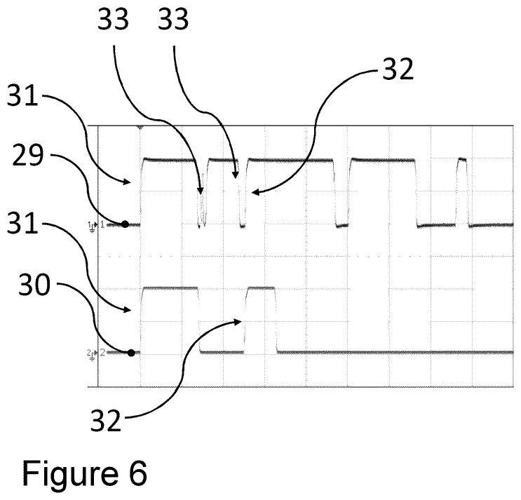

FIG. 6 shows the results of further measurement on a reaction tube having encrusted inner walls, and

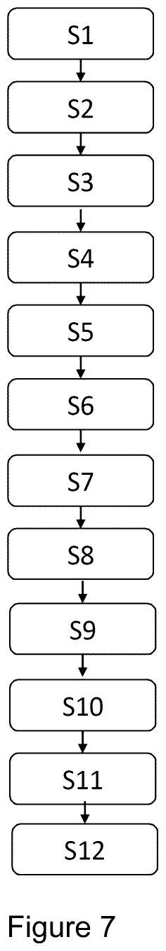

FIG. 7 is a flow chart of the method steps of a first exemplary embodiment of the method according to the invention.

An exemplary embodiment of the arrangement 50 according to the invention is described with reference to FIGS. 1 to 6:

The arrangement 50 comprises a tube-bundle reactor 1. The tube-bundle reactor 1 is delimited by a reactor casing, a cylindrical body, wherein an upper hood and a lower hood close the reactor casing in a gas-tight manner at the upper and lower end of the reactor casing. A plurality of vertically arranged reaction tubes 3 is arranged in the interior of the tube-bundle reactor 1 in such a way that the reactor casing surrounds the reaction tubes 3. The upper ends of the reaction tubes 3 are each connected in a gas-tight manner to an upper tube base and the lower ends of the reaction tubes 3 are each connected in a gas-tight manner to a lower tube base, i.e. both ends of the reaction tubes 3 are enclosed in the tube bases. The space between the upper hood and the upper tube base, the space inside the reaction tubes 3, and the space between the lower tube base and the lower hood therefore form a gas-tight reaction chamber. The feed gas mixture is introduced into the tube-bundle reactor 1 in this reaction chamber, subjected to a chemical reaction intended in the tube-bundle reactor 1 in the interior of the reaction tubes 3, and then discharged again from the tube-bundle reactor 1.

The tube-bundle reactor 1 has 10 000 to 40 000 reaction tubes 3. Their internal diameter is 25 mm; the total length of the reaction tube 3 is 3200 mm. The reaction tubes 3 are arranged in a grid so that a repeating linear pattern results. One possible grid arrangement is shown in FIG. 1; however, other repeating linear patterns are also possible. The reaction tubes 3 are cylindrical and are open on top. For operation of the tube-bundle reactor 1, they are filled with particles of a catalyst material 4. The catalyst particles have a cylindrical shape having diameters from 5 to 7 mm and a height of 4 to 7 mm. The distance of the opening of the reaction tube 3 from the surface of the particles 4 of the catalyst material is 100 to 700 mm depending on the fill level.

To determine the fill level height of the reaction tubes 3 with the particles of the catalyst material 4, a sensor device 2 having ultrasonic sensors 6 and an electronics box 5 is located above the reaction tubes 3. The electronics box 5 contains a first control device 26, a second control device 27, a calculation unit 28, an alignment device 14, an evaluation device 7, a temperature probe, and display and operating elements. The ultrasonic sensors 6 are actuated via the first control device 26. They are fastened in the vertical direction at the least possible distance of less than 30 mm above the openings of the reaction tubes 3, so that they can be moved in a horizontal plane above the openings of the reaction tubes 3. The emission characteristic of each ultrasonic sensor 6 is an ultrasonic lobe. Its vertical axis of symmetry is in each case aligned parallel to a vertical axis of symmetry of a reaction tube 3.

The ultrasonic sensor 6 has, as shown in FIG. 2, an ultrasound transducer head 17 having a decoupling surface 18 for emitting the ultrasonic signal. An adaptation layer for adapting the emission characteristic of the ultrasonic sensor 6 to the geometry of the inner walls of the reaction tubes 3 is arranged on the decoupling surface 18. The thickness of the adaptation layer is greater in the center of the decoupling surface 18 than at the edge. The adaptation layer consists of one or more adhesive films. In FIG. 2, the adaptation layer consists of two concentrically attached adhesive films 20, 21 having different diameters. A first adhesive film 20 is fastened tightly to the decoupling surface 18 and covers it completely. A second film 21, which is smaller than the first film, is fastened on the side of the first film 20 facing away from the decoupling surface 18 in the center of the decoupling surface 18, so that the thickness of the adaptation layer is greater in the center of the decoupling surface 18 than at the edge. The thickness of the first adhesive film 20 is 130 μm and it covers the complete decoupling surface 18, the thickness of the second adhesive film 21 is 130 μm, its diameter is 6.5 mm, and it is fastened centrally on the first film 20. Self-adhesive plastic films (Tesaflex® 53948) made of soft PVC and having a thickness of 130 μm are used.

The disk-shaped films 20 and 21 are therefore arranged concentrically in relation to one another. The ratio of their diameters is approximately 0.26, the ratio of their areas is approximately 0.07. As shown below, it has been shown that an adaptation layer formed in this way has the result that during measurements on the reaction tubes 3, measurement errors due to encrustations or adhesions on the inner walls of the reaction tube 3 do not occur.

The evaluation device 7 is coupled with the ultrasonic sensors 6 via a data connection 8. Data on the time of the emission and the reception of the ultrasonic signal are stored in the evaluation device 7. A time-of-flight determination takes place and the fill level height is ascertained therefrom. The fill level height is the distance of the base of the reaction tube 3, on which the particles 4 of the catalyst material rest, to the upper surface formed by the particles 4 of the catalyst material. Initially the distance of the surface of the ultrasound transducer head 17 to the surface of the particles 4 of the catalyst material is calculated from the time-of-flight of the ultrasonic signal, wherein it is taken into consideration that the ultrasonic signal runs from the ultrasonic sensor 6 to the surface of the particles 4 and runs back again after the reflection. Since the distance of the surface of the ultrasound transducer head 17 above the upper edge of the reaction tube 3 is known and in addition the distance of this upper edge of the reaction tube 3 to the base on which the particles 4 of the catalyst material rest is known, the fill level height can be calculated from the time-of-flight of the ultrasonic signal.

The evaluation device 7 is coupled with a temperature probe 24, which continuously measures the temperature in the surroundings of the reaction tubes 3. Using the temperature thus ascertained, the numeric value of the speed of sound is adapted via the known dependency of the speed of sound on the temperature for the evaluation of the measurement results in the evaluation device 7.

An indicator 9 which is placed on the sensor device 2 displays an optical signal that is dependent on the ascertained fill level height of the evaluation device 7. The desired fill level height or an interval of desired fill level heights is stored in the evaluation device 7. It is output by means of LEDs whether the fill level height is in the specified range. The result of the measurement is displayed on an LED bar. Each measured reaction tube 3 is assigned three different-colored LEDs. A loudspeaker 10 is furthermore provided, which can generate an acoustic signal.

The arrangement 50 furthermore comprises an alignment device 14. This aligns the ultrasonic sensors 6 into a measurement-ready state. For this purpose, these sensors are fastened on a measuring carriage 11, which is attached on a rail system 12 above the openings of the reaction tubes 3 and is movable in a horizontal plane above the openings of the reaction tubes 3 by means of profile rollers 13. The movement of the measuring carriage 11 takes place in the operating mode “automatic” with the aid of an electrically driven geared motor and is controlled by a second control device 27. Alternatively, the measuring carriage can also be moved by hand in the operating mode “manual”. The drive unit provided for the automatic operation can be decoupled for this purpose. The ultrasonic sensors 6 are arranged adjacent to one another on the measuring carriage 11 so that they correspond to the repeating linear pattern of the grid of the reaction tubes 3.

During a movement of the measuring carriage 11, the ultrasonic sensors 6 therefore move above the openings of the reaction tubes 3. After a specific advance of the measuring carriage 11, the vertical axes of the row of the ultrasonic sensors 6 coincide with the axes of the reaction tubes 3 located underneath. For example, overlaps of ten reaction tubes 3 with ultrasonic sensors 6 are achieved. The ultrasonic sensors 6 are thus arranged on the measuring carriage 11 so that due to the displacement of the measuring carriage 11 and thus the ultrasonic sensors 6, one row of reaction tubes 3 of the grid is measured by the row of ultrasonic sensors 6 on the measuring carriage 11.

Damping layers made of felt are attached to the underside of the measuring carriage 11 so that reflections of adjacent ultrasonic sensors 6 are suppressed. Furthermore, the ultrasonic sensors 6 are actuated so that they do not all emit ultrasonic signals simultaneously, but rather always only every second sensor, so that an interfering signal is not received from the adjacent sensor.

Light barrier sensors 22 and a calculation unit 28 are located on the alignment device 14. The light barrier sensors 22 consist of two light barrier pairs. During the displacement of the sensor device 2, they detect the relative location of the ultrasonic sensor 6 to the reaction tube 3 in the horizontal plane. Two light barrier sensors 22 shifted in relation to one another in the direction of travel of the measuring carriage 11 are combined to form a pair for the tube detection. The offset of the light barrier sensors 22 in relation to one another is approximately 5 mm less than the tube diameter of the reaction tube 3. For reliable detection of the tube openings, there are two of these light barrier pairs, which are interconnected to form an OR linkage. It is stored in the calculation unit 28 how the ultrasonic sensor 6 has to be moved by means of the measuring carriage 11 in order to align it so that the vertical axis of the ultrasonic sensor 6 coincides with the vertical axis of the reaction tube 3, so that the ultrasound transducer head 17 is aligned centrally above the reaction tube 3.

Furthermore, the travel speed of the measuring carriage 11 is monitored by the light barrier sensors 22. The optical indicator 9 and loudspeaker 10 are also coupled with the measuring carriage 11, so that LEDs and warning signals are actuated in dependence on the behavior of the measuring carriage 11. In the event of excessively fast manual movement of the measuring carriage 11 or if none of the light barrier pairs can detect a correct measuring position during the automatic journey of the measuring carriage 11, a warning tone sounds.

A rechargeable accumulator 15 ensures the voltage supply of the sensor device 2 and the components of the alignment device 14. The accumulator 15 is connected to the ultrasonic sensors 6 and the light barrier sensors 22 and is installed on the measuring carriage 11.

To ascertain the effect of the adaptation layer, measurements of the arrangement were carried out on a reaction tube 3. The results of these measurements are explained hereinafter with reference to FIGS. 4 to 6:

During the measurements, the ultrasonic sensor 6 emits an ultrasonic pulse into the reaction tube 3. A time measurement is started at the same time. The ultrasonic pulse is then reflected by the medium located in the tube and it then strikes the ultrasonic sensor 6 again. At this time, the time measurement is stopped and the evaluation device 7 calculates, with incorporation of the detected ambient temperature and the speed of sound, the time-of-flight of the ultrasonic pulse and therefrom the distance of the surface of the ultrasound transducer head 17 of the ultrasonic sensor 6 from the medium at which the ultrasonic pulse was reflected. The fill level, i.e. the distance of the upper surface formed by the particles 4 of the catalyst material to the ultrasound transducer head 17, and the fill level height can then be calculated therefrom.

First measurements were carried out in each case using an ultrasonic sensor 6, in which no adaptation layer was applied to the ultrasound transducer head 17. The signal 29 of these measurements is shown in FIGS. 4 to 6. Furthermore, second measurements were carried out in each case, in which the ultrasound transducer head 17 was provided as described above with the adaptation layer, i.e. the adhesive films 20 and 21. This signal 30 of this respective measurement is also shown in FIGS. 4 to 6.

FIG. 4 shows the result of the measurements on a reaction tube 3 having clean, i.e. smooth inner walls. The fill level was 707 mm. The signals 29 and 30 shown in FIG. 4 show, on the one hand, the emitted pulse 31 of the ultrasonic sensor 6 and, on the other hand, a reception signal 32 which results from the reflection of the ultrasonic pulse on particles 4 of the catalyst material. In the measurements shown in FIG. 4, in which the inner walls of the reaction tube 3 were smooth, an accurate and error-free measurement of the fill level results in both cases.

In practical application not under laboratory conditions, but rather using reaction tubes 3 which are actually in use in a tube-bundle reactor 1, however, frequent measurement errors occurred, which made a reliable calculation of the fill level height and the fill level impossible. An error analysis showed that the reaction tubes 3 which are in use in a tube-bundle reactor 1 have slight encrustations on the inner walls, which already reflect a part of the ultrasonic pulse. However, the evaluation device 7 cannot distinguish between the reflections on the inner wall of a reaction tube 3 and those on the particles 4 of the catalyst material.

To solve the problem of the frequent measurement errors, the inner walls of test tubes were coated using various substances in the laboratory in order to simulate the encrustations from practice. Further experiments were then carried out on these tubes:

Further measurements were carried out using an ultrasonic sensor 6, in which the ultrasound transducer head 17 has not been provided with an adaptation layer. The signals 29 of these measurements are shown in FIGS. 5 and 6. The fill level of the measurements shown in FIG. 5 was again 707 mm; the fill level of the measurements shown in FIG. 6 was again 207 mm. It was again shown that a reliable calculation of the fill level height and the fill level of the particles 4 of the catalyst material was not possible from these signals 29.

Furthermore, measurements were carried out using an ultrasonic sensor 6 in which, as explained above, the adaptation layer, i.e. the two films 20 and 21, were applied to the ultrasound transducer head 17. The signals 30 of these measurements are shown in FIGS. 5 and 6. A clear improvement of the signal quality was achieved.

If one compares the signal 29 with the signal 30 in FIGS. 5 and 6, it is shown that in the measurements using the ultrasonic sensor 6 in which the ultrasound transducer head 17 is provided with the adaptation layer, the reflections from the inner walls could be reduced enough that they were no longer detected by the ultrasonic sensor 6. This result was confirmed in further test measurements on the reaction tubes 3 of a tube-bundle reactor 1 in use. It was possible to preclude measurement errors by the application of the adaptation layer to the ultrasound transducer head 17, which occur due to encrustations or the like on the inner walls of the reaction tube 3.

An exemplary embodiment of the method according to the invention for determining the fill level height of the particles of a catalyst material 4 in the reaction tubes 3 of a tube-bundle reactor 1 by means of the above-described arrangement 50 as shown in FIG. 7 is described hereinafter.

In a first step S1, target values for the time-of-flight measurements and a range for permitted fill level heights are stored in the evaluation device 7.

In a second step S2, the ultrasonic sensors 6 are moved by means of the second control device 27 above the reaction tubes 3. The relative horizontal location of the ultrasonic sensors 6 to the reaction tubes 3 is measured here using two light barrier sensors 22. As long as both light barrier sensors 22 detect the tube openings simultaneously and the ultrasonic sensors are located in a defined area around the center axis of the tube openings, distance measurements are triggered and enabled by means of the first control device 26. The pairs of the light barrier sensors 22 are attached on the measuring carriage 11 directly in front of the ultrasonic sensors 6 arranged adjacent to one another and detect the reaction tubes 3 via reflection measurements. If both light barrier sensors 22 detect that the ultrasonic sensors 6 are placed above the reaction tubes 3, the ultrasonic measurement is started. It is thus possible to measure within the reaction tube 3, which has a diameter of 20 to 25 mm, in a range of approximately 8 mm; otherwise undesired reflections would occur. Ultrasonic measurements for determining the fill level height of multiple reaction tubes 3 are carried out simultaneously, wherein ultrasonic sensors 6 arranged in a row are activated alternately for the measurement. In this case, adjacent ultrasonic sensors 6 are not activated simultaneously, but rather ultrasonic sensors 6 located adjacent to one another are triggered alternately.

In a third step S3, activated ultrasonic sensors 6 emit an ultrasonic signal from above into reaction tubes 3 located underneath. At the emission time, in a fourth step S4, a signal is transmitted to the evaluation device 7 to store the starting time. The ultrasonic signal reflected in the reaction tube 3 is received by the ultrasonic sensor 6 in a fifth step S5. The received signal is also transmitted to the evaluation device 7 in a sixth step S6. This procedure is repeated multiple times in a measuring period for a reaction tube 3. In a seventh step S7, a plurality of times-of-flight of emitted ultrasonic signals is determined therefrom. In an eighth step S8, the times-of-flight are compared in the evaluation device 7 to the stored permitted time-of-flight interval and those times-of-flight are filtered out which lie outside the permitted time-of-flight interval. In a ninth step S9, the fill level height of the particles of the catalyst material 4 is calculated with the aid of the speed of sound from the times-of-flight thus filtered using the last ascertained permitted value. For this purpose, the last value located in the permitted time-of-flight range which was recorded in a measuring period is used. The mean distance covered by the ultrasonic signal is determined from the time-of-flight value thus ascertained via the principle of uniform movement. Since the speed of sound is temperature dependent, a temperature measurement also takes place continuously via the additionally installed temperature probe 24 and the speed of sound used for the calculation is adapted in the evaluation device 7.

The result for the fill level height is compared in a tenth step S10 to stored target values. The measured result in millimeters is displayed on a display 25 in an eleventh step S11. In addition, the result is displayed on an LED bar: If the measured value is within the target value interval, a green LED lights up. If a tube fill level height is below or above the desired level, it thus does not correspond to the target value range, a red LED lights up. If the procedure has been identified as not measurable, a yellow LED lights up. In the last two cases, a brief warning tone additionally sounds. The result is retained until the next measurement of a reaction tube 3 has taken place.

After completed measurement, the ultrasonic sensors 6 are moved by means of the second control device 27 in a twelfth step S12 to the next row of reaction tubes 3. For this purpose, these sensors are fastened on the measuring carriage 11, as described in the exemplary embodiment of the arrangement according to the invention. This carriage moves at slow constant speed on the rail system 12 above the reaction tubes 3 to be measured. This takes place automatically by means of a motor. In another exemplary embodiment, the motor drive is decoupled and the measuring carriage is moved by manual pushing or pulling on the rail system 12 above the reaction tubes 3. The measuring carriage 11 moves continuously; it thus also continues to move during the measuring procedure. The speed of the measuring carriage 11 is continuously measured in this case and a warning signal sounds at excessively high speed.

The measuring carriage 11 automatically continues to travel after completed measurement in order to position the ultrasonic sensors 6 above a new row of reaction tubes 3. Since the positioning of the ultrasonic sensors 6 on the measuring carriage 11 is matching with the grid of the reaction tubes 3, after a specific advance of the measuring carriage 11, the vertical axes of multiple ultrasound transducer heads 17 coincide with the vertical axes of reaction tubes 3 located underneath. The fill level heights of a further row of reaction tubes 3 can therefore be measured. The measuring carriage 11 can be moved at an amble linearly above the reaction tubes 3 with an arrangement of the reaction tubes 3 in triangular spacing. The alignment device 14 ensures in each case here that the ultrasonic sensors 6 are moved above the upper openings of the reaction tube 23 and the measurements are executed essentially in an area in which the vertical axis of symmetry of the ultrasonic lobe essentially coincides in each case with the vertical axis of symmetry of a reaction tube 3.

The alignment device 14, the ultrasonic sensors 6, and the associated evaluation device 7 are supplied with electrical energy via an accumulator 15. The accumulator 15 is charged as soon as necessary when no measurements are currently taking place.

### LIST OF REFERENCE NUMERALS

1 tube-bundle reactor
2 sensor device
3 reaction tubes
4 particles of the catalyst material
5 electronics box having operating and display elements
6 ultrasonic sensor
7 evaluation device
8 data connection
9 indicator
10 loudspeaker
11 measuring carriage
12 rail system
13 profile rollers
14 alignment device
15 accumulator
17 ultrasound transducer head
18 decoupling surface
20 first film
21 second film
22 light barrier sensors
24 temperature probe
25 display
26 first control device
27 second control device
28 calculation unit
29 signal without adaptation layer
30 signal with adaptation layer
31 emitted pulse
32 reception signal due to reflection on particles of the catalyst material
33 reception signals due to reflections on encrustations
50 arrangement

1.-15. (canceled)

16. An arrangement of a tube-bundle reactor and a sensor device,
wherein the tube-bundle reactor comprises a bundle of vertically arranged reaction tubes, which are open on top through upper openings and are fillable with particles of a catalyst material,
wherein
the sensor device comprises an ultrasonic sensor and an evaluation device,
wherein the ultrasonic sensor is designed to emit an ultrasonic signal from above into one of the reaction tubes and to receive the ultrasonic signal reflected in the reaction tube, and
wherein the evaluation device is coupled with the ultrasonic sensor via a data connection and is designed to ascertain the distance of the surface of the particles of the catalyst material received by the one reaction tube to the ultrasonic sensor from the time-of-flight of the received ultrasonic signals and to ascertain a fill level height of the catalyst material in the reaction tube therefrom.

17. The arrangement according to claim 16, wherein the ultrasonic sensor comprises an ultrasound transducer head having a decoupling surface for emitting the ultrasonic signal and an adaptation layer is arranged on the decoupling surface for adapting the emission characteristic of the ultrasonic sensor to the geometry of the reaction tubes.

18. The arrangement according to claim 17, wherein the thickness of the adaptation layer is greater in the center of the decoupling surface than at the edge.

19. The arrangement according to claim 17, wherein the adaptation layer has a first film, which is tightly fastened on the decoupling surface).

20. The arrangement according to claim 19, wherein the adaptation layer has a second film, which is smaller than the first film and is fastened on the side of the first film facing away from the decoupling surface in the center of the decoupling surface, so that the thickness of the adaptation layer is greater in the center of the decoupling surface than at the edge.

21. The arrangement according to claim 16, wherein the sensor device has an indicator, which is designed to display an optical signal that is dependent on the ascertained fill level height of the evaluation device.

22. The arrangement according to claim 16, wherein the ultrasonic sensor is fastened on a measuring carriage, which is attached on a rail system above the openings of the reaction tubes and is movable in a horizontal plane above the openings of the reaction tubes.

23. The arrangement according to claim 16, wherein the arrangement comprises an alignment device having light barrier sensors, which is designed to detect the relative location of the ultrasonic sensor to the reaction tube in a horizontal plane.

24. The arrangement according to claim 16, wherein the sensor device comprises multiple ultrasonic sensors.

25. The arrangement according to claim 16, wherein the reaction tubes are arranged in the tube-bundle reactor in a grid, so that a repeating linear pattern results.

26. The arrangement according to claim 24, wherein the ultrasonic sensors are arranged on the measuring carriage so that they correspond to the repeating linear pattern of the grid of the reaction tubes.

27. A method for determining the fill level height of a catalyst material in the reaction tubes of a tube-bundle reactor,
wherein the tube-bundle reactor comprises a bundle of vertically arranged reaction tubes, which are open on top through upper openings and are filled with particles of a catalyst material,
wherein
a sensor device comprises an ultrasonic sensor, using which an ultrasonic signal is emitted from above into one of the reaction tubes and the ultrasonic signal reflected in the reaction tube is received,
the received signal is transmitted via a data connection to an evaluation device, and the evaluation device ascertains the distance of the surface of the particles of the catalyst material received by a reaction tube to the ultrasonic sensor from the time-of-flight of the received ultrasonic signals and ascertains the fill level height of the catalyst material in the reaction tube therefrom.

28. The method according to claim 27, wherein the ultrasonic sensor, which is fastened on a measuring carriage, is moved on a rail system by means of guide rollers in a horizontal plane above the openings of the reaction tubes and the relative horizontal location of the ultrasonic sensor to the reaction tube is measured by means of light barrier sensors and the ultrasonic sensor is aligned so that the ultrasonic sensor is located centrally above an opening of a reaction tube.

29. The method according to claim 28, wherein multiple ultrasonic sensors are arranged adjacent to one another on the measuring carriage, and ultrasonic measurements for determining the fill level height of multiple reaction tubes are carried out simultaneously, wherein the ultrasonic sensors are alternately activated for the measurement.

30. The method according to claim 27, wherein a plurality of times-of-flight of emitted ultrasonic signals are received and stored in a measuring period for a reaction tube, the times-of-flight are compared in the evaluation device to a stored permitted time-of-flight interval, those times-of-flight are filtered out which lie outside the permitted time-of-flight interval, the fill level height of the catalyst material is ascertained from the permitted times-of-flight.
